(19) United States
(12) Patent Application Publication
(10) Pub. No.: US 2013/0008319 A1
(43) Pub. Date: Jan. 10, 2013

(54) Pet Treat Baking Machine

(76) Inventor: Louis John Kokenis, Arnold, MO (US)

(21) Appl. No.: 13/422,119

(22) Filed: Mar. 16, 2012

Related U.S. Application Data
(60) Provisional application No. 61/505,588, filed on Jul. 8, 2011.

(51) Int. Cl. A47J 37/00

(52) U.S. Cl. 99/344; 99/380

(57) ABSTRACT

An architecture is presented that provides a pet treat baking kit designed to make healthy and affordable pet treats. The pet treat baking kit comprises a pet treat baking device, a recipe book, a wire cooling rack, and an utensil. The pet treat baking device, comprises a top portion and a bottom portion secured together to form a hinge at a first end. The pet treat baking device further comprises a heating element secured to an interior of either the top portion or the bottom portion of the device, and at least one baking plate removably secured to the interior of the bottom portion. Furthermore, the pet treat baking device comprises at least one baking plate removably secured to an interior of the top portion of the device. The baking plates comprise molds in various shapes, such as a dog bone shape, a paw shape, or an animal shape.

### CROSS-REFERENCE

This application claims priority from Provisional Patent Application Ser. No. 61/505,588 filed Jul. 8, 2011.

### BACKGROUND

Many pet owners buy treats from the grocery store or pet store for their pets. However, buying such pet treats is costly, especially for owners with multiple pets. Furthermore, some pets have sensitivities to certain types of food and/or ingredients, and are allergic to store-bought treats. Additionally, many of these pet treats contain preservatives and other unhealthy ingredients. However, purchasing organic pet treats is even more expensive for pet owners. Consequently, an effective solution is necessary.

There is a need for an inexpensive and healthy pet treat that can be prepared by an owner. The present invention discloses a pet treat making device for home use. The device is designed to make pet treats that are healthy and affordable. The product can be used by pet lovers at home, or a larger unit can be used in pet bakeries or grocery stores. The device saves users money by allowing users to bake healthy pet snacks within their own home. The device comes with a recipe book of fun, preservative-free recipes that include allergy-sensitive treat options. Not only is the product economical, but it also provides a fun, unique activity that can be enjoyed by the whole family. Users will appreciate the convenience and efficiency that this invention affords.

### SUMMARY

The following presents a simplified summary in order to provide a basic understanding of some aspects of the disclosed innovation. This summary is not an extensive overview, and it is not intended to identify key/critical elements or to delineate the scope thereof Its sole purpose is to present some concepts in a simplified form as a prelude to the more detailed description that is presented later.

The subject matter disclosed and claimed herein, in one aspect thereof, comprises a pet treat baking kit designed to make healthy and affordable pet treats. The pet treat baking kit comprises a pet treat baking device, a recipe book, a wire cooling rack, and an utensil. The pet treat baking device, comprises a top portion and a bottom portion secured together to form a hinge at a first end. The pet treat baking device further comprises a heating element secured to an interior of either the top portion or the bottom portion of the device, and at least one baking plate removably secured to the interior of the bottom portion. It is also contemplated that the pet treat baking device could be offered as a stand alone device (i.e., without the remaining kit items).

In a preferred embodiment of the present invention, the pet treat baking device further comprises at least one baking plate removably secured to an interior of the top portion of the device. The baking plates comprise molds that could be produced in a variety of shapes including, without limitation, the shape of a dog bone, an animal paw, or an animal. The pet treat baking device may further comprises an internal timing component that emits an audible sound at a predetermined time. Specifically, the internal timing component alerts a user when the baking is complete by emitting a beep, a ring, a bark, or some other sound.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of a pet treat baking device in accordance with the disclosed architecture.

FIG. 2 illustrates a perspective view of the interior of but one embodiment of the pet treat baking device in accordance with the disclosed architecture.

FIG. 3 illustrates a perspective view of but one embodiment of the baking plate of the pet treat baking device in accordance with the disclosed architecture.

FIG. 4 illustrates a bottom sectional view of the baking plate depicted in FIG. 3, and the heating element of the pet treat baking device in accordance with the disclosed architecture.

FIG. 5 illustrates a perspective view of the pet treat baking device with a design in accordance with the disclosed architecture.

FIGS. 6 A-B illustrate a perspective view of one possible embodiment of the pet treat baking device in use in accordance with the disclosed architecture.

FIG. 7 illustrates a perspective view of the pet treat baking kit in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses a pet treat baking kit and pet treat baking device designed to make healthy and affordable pet treats. The pet treat baking kit and pet treat baking device can be used by pet lovers at home, or a larger unit can be used in pet bakeries, grocery stores or other public or commercial settings. The device is comprised of a durable plastic clamshell exterior design with two interior non-stick baking plates. The baking plates are designed with various shaped molds to create the shape of the pet treat. The pet treat baking kit also comes with a wire cooling rack, a utensil such as a two-pronged fork for easy removal of the baked treats from the device, and a recipe book with healthy, allergy-sensitive pet treat options. The kit and device saves users money by allowing users to bake healthy pet snacks within their own home. The pet treat baking device can be manufactured in a variety of solid colors or patterns, or may be available in various designs and may include beads, gems, rhinestones, or other accessories as is known in the art.

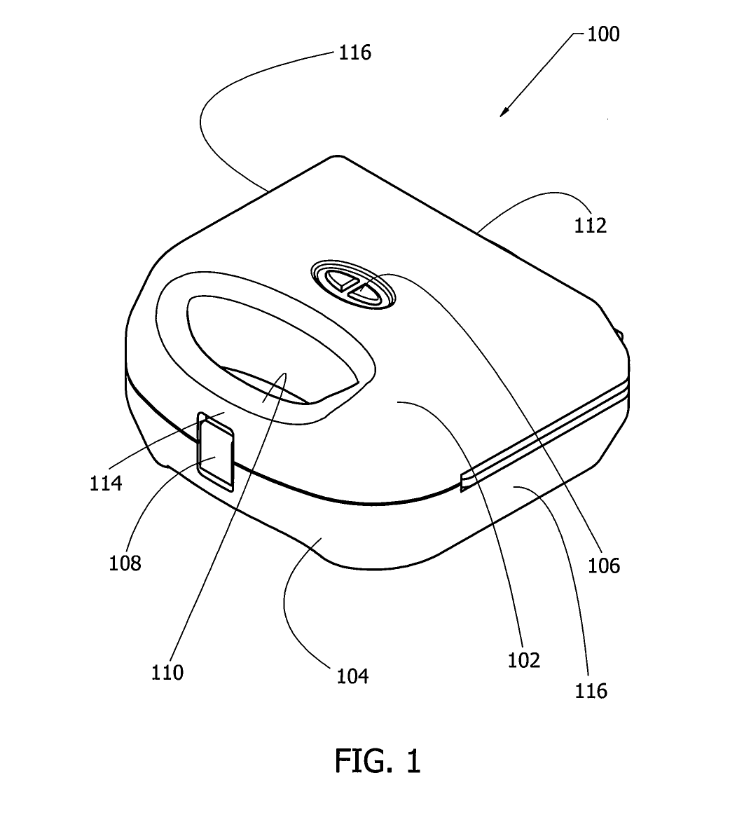

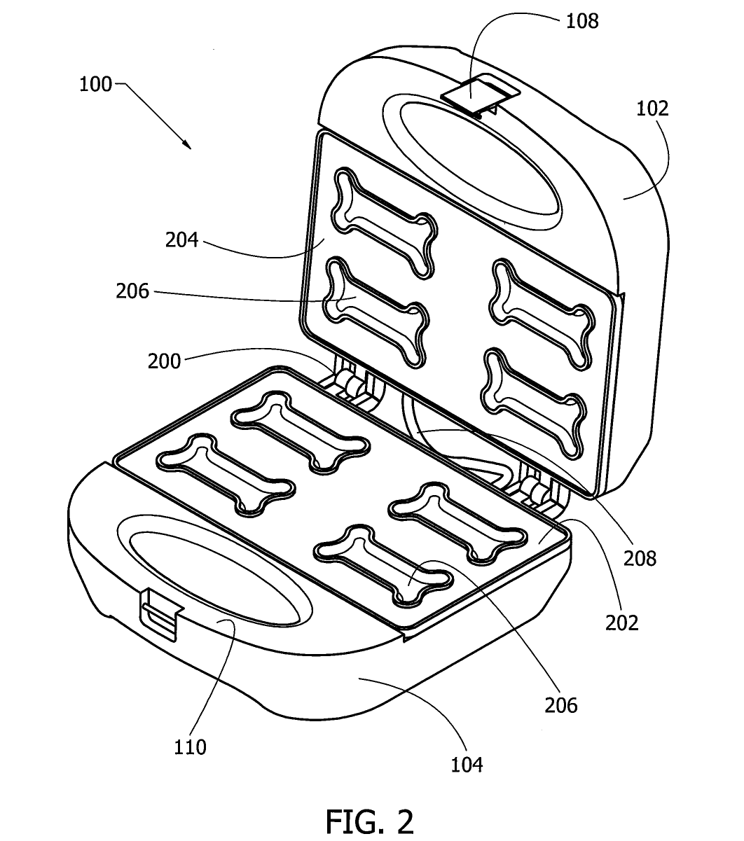

Referring initially to the drawings, FIG. 1 illustrates a perspective view of one embodiment of a pet treat baking device 100 in a closed position and designed to make healthy and affordable pet treats. The pet treat baking device 100 comprises a top portion 102, a bottom portion 104, sides 116, a first end 112 and a second end 114, and an electrical cord (not shown) to power the device 100. Typically, the top portion 102 and the bottom portion 104 are the same general size and are complementarily shaped to one another; however the top portion 102 and the bottom portion 104 do not have to be the same size and shape, and can be any suitable size or shape as is known in the art. Furthermore, the top portion 102 and the bottom portion 104 are positioned along the first end 112, as shown in FIG. 2. Hinge (shown in FIG. 2 as 200) can be any suitable hinge that is known in the art including, without limitation, a living hinge, a floating hinge, a piano hinge, etc. The hinge includes stops that prevent the top portion 102 and the bottom portion 104 from opening 180 degrees. Specifically, the mirrored top portion 102 and bottom portion 104 when secured together at the first end 112 form a clamshell, or other suitable shape as is known in the art without affecting the overall concept of the invention.

Additionally, the top portion 102 and the bottom portion 104 can be secured in a closed position at the second end 114, via a latching component 108. The latching component 108 can be any suitable latching mechanism as is known in the art such as a clip, a clasp, etc. The latching component 108 secures the top portion 102 and the bottom portion 104 together and prevents the top portion 102 and bottom portion 104 from separating during transport or during the baking process without user intervention. Further, the second end 114 can comprise a handle 110 for ease in transporting the device 100. The handle 110 can be any suitable shape or size for a user's hand to grasp to transport the device 100. The handle 110 can be a separate piece that is secured to the second end 114 via welding, gluing, or any other suitable means of securing as is known in the art. In contrast, the handle 110 can be an integral part of the top portion 102 and bottom portion 104, and can be manufactured as a one-piece article.

Additionally, the top portion 102 and the bottom portion 104 are generally rectangular-shaped, however any other suitable shape, such as square, oval, circle, etc., can be used as is known in the art without affecting the overall concept of the invention. The top portion 102 and the bottom portion 104 would generally be constructed of a durable thermoplastic, or other polymer, nylon, polycarbonate, acrylonitrile butadiene styrene (ABS), polyvinyl chloride (PVC), etc., though any other suitable material may be used to manufacture the top portion 102 and the bottom portion 104 as is known in the art without affecting the overall concept of the invention.

Furthermore, the pet treat baking device 100 can be manufactured in a variety of sizes depending on a user's need and desires. A smaller unit can be manufactured for home use. Specifically, the pet treat baking device 100 for home use would be approximately between 8 and 9 inches in length as measured from first end 112 to second end 114, approximately between 7 and 8 inches wide as measured between sides 116, and approximately between 3 and 4 inches thick, as measured from top surface 102 to bottom surface 104. However, the pet treat baking device 100 can also be manufactured in a larger size for commercial use. Specifically, the pet treat baking device 100 for commercial use would be approximately between 10 and 20 inches in length as measured from first end 112 to second end 114, approximately between 20 and 30 inches wide as measured between sides 116, and approximately between 4 and 6 inches thick, as measured from top surface 102 to bottom surface 104.

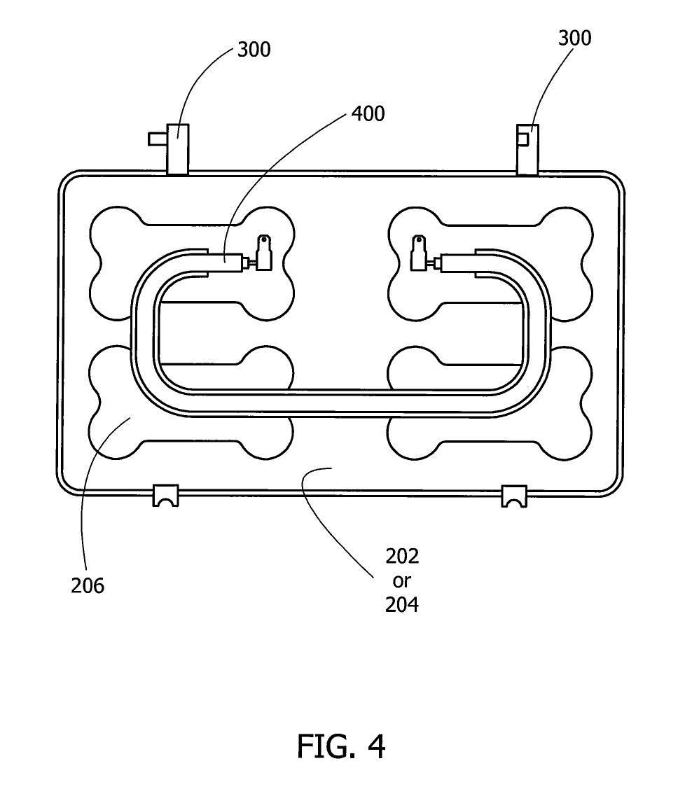

The pet treat baking device 100 further comprises a heating element (shown in FIG. 4 as 400) secured to an interior of either the top portion 102 and/or the bottom portion 104 of the device 100. The heating element would typically be a resistive, electrical heating element that would be powered by plugging the electrical cord of the device 100 into a wall outlet. However, any other suitable heating element can be used as is known in the art. Specifically, an electrical cord (shown in FIG. 2 as 208) connects the heating elements together and provides power to both heating elements. The heating element functions to heat up the baking plates (shown in FIGS. 2 as 202 and 204) of the device 100 and to maintain the baking plates of the device 100 at a constant temperature during the baking process. Additionally, two pilot lights 106 are typically located on the top portion 102 of the device 100 and indicate when the device 100 has reached the appropriate temperature. Further, the pilot lights 106 can be located at any other suitable position on the device 100 as is known in the art without affecting the overall concept of the invention. Typically, the temperature of the internal temperature of the device 100 is constant and not adjustable, but it is contemplated that the device 100 could include a thermostat which would allow a user to control and adjust the internal temperature of the device 100.

The pet treat baking device 100 may further comprise an internal timing component (not shown) that emits an audible sound at a predetermined time. Specifically, the internal timing component alerts a user when the baking process is complete. After a predetermined time period, the baking is complete and the internal timing component emits an audible sound. The predetermined time period is typically set during the manufacturing of the device, but could also be set by the user. The timing device may manufactured as a dial, touchpad, pushpad, or any other suitable means for measuring time as is known in the art. The audible sound comprises at least one of a beep, a ring, a bark, or other animal sound, or any other suitable sound as is known in the art. In a preferred embodiment, the internal timing component produces an audible barking noise to alert the user that the baking process is complete. Further, the device may comprise an automatic shut-off component. The automatic shut-off component will automatically shut-off the device 100 after a predetermined period of non-use.

FIG. 2 illustrates the interior of the pet treat baking device 100. The pet treat baking device 100 comprises at least one baking plate 202 removably secured to the interior of the bottom portion 104. Additionally, the pet treat baking device 100 further comprises at least one baking plate 204 removably secured to an interior of the top portion 102. The baking plates 202 and 204 are typically non-stick and can be any suitable shape or size as is known in the art, and can be removed and interchanged as desired. The baking plates 202 and 204 are typically removably secured on the top portion 102 and/or bottom portion 104 of the device 100 via any suitable securing means as is known in the art, such as spring clips, set screws, thumb screws, etc. Typically, the baking plates 202 and 204 secure directly to the hinge 200 of the top portion 102 and the bottom portion 104.

The baking plates 202 or 204 also comprise molds 206 or forms, which can be provided in a variety of shapes. Typically, the shapes comprise at least one of a dog bone shape, an animal paw shape, or an animal shape. However, the molds 206 can be any suitable shape or size as is known in the art without affecting the overall concept of the invention. Thus, the pet treat baking device 100 can bake any type or size of pet treat as is known in the art. Specifically, once the desired amount of molds 206 are filled, the user grasps the handle 110 of the device 100 and pulls the top portion 102 of the device 100 down to the bottom portion 104, such that the molds 206 of the baking plate 204 align with the molds 206 of the baking plate 202 during the baking process. Once the device 100 is closed, a user then secures the top portion 102 and the bottom portion 104 together via the latching component 108 and plugs the device 100 in via an electrical cord, to power the device 100. Further, electrical cord 208 provides power to both of the heating elements, which serve to heat the baking plates 202 and 204 during the baking process.

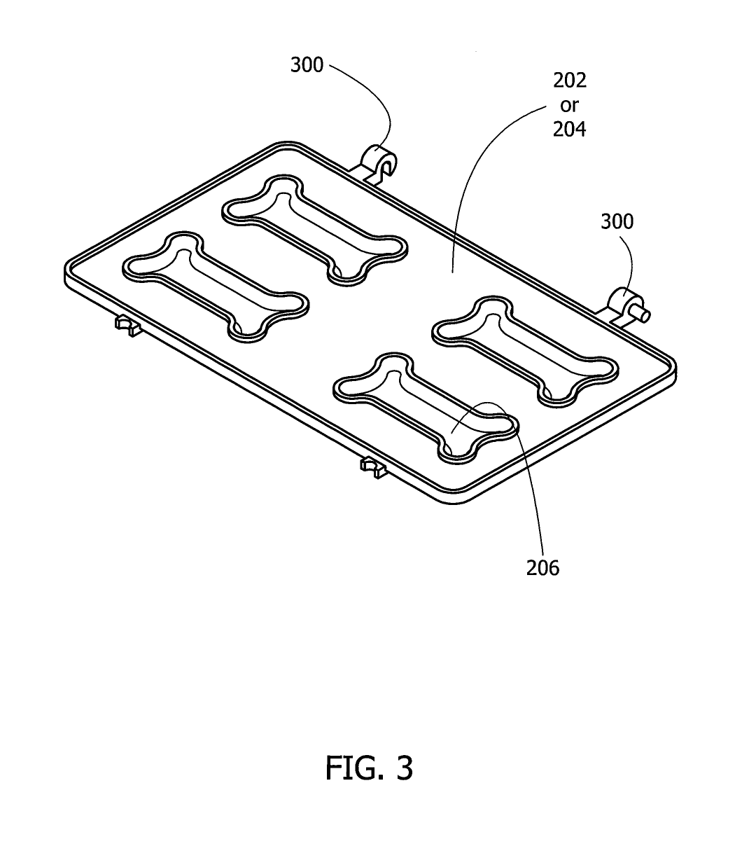

FIG. 3 illustrates the baking plate 202 or 204 of the pet treat baking device. The baking plate 202 or 204 can be removably secured to the interior of either the top portion or the bottom portion of the device. The baking plates 202 and 204 can be any suitable shape or size as is known in the art, and can be removed and interchanged as desired. The baking plates 202 and 204 are typically removably secured on the top portion and/or bottom portion of the device via any suitable securing means 300 as is known in the art, such as spring clips, set screws, thumb screws, etc.

The baking plates 202 or 204 also comprise molds 206 or forms in a variety of shapes. Typically, the shapes comprise at least one of a dog bone shape, an animal paw shape, or an animal shape. However, the molds 206 can be any suitable shape or size as is known in the art without affecting the overall concept of the invention. Thus, the pet treat baking device can bake any type or size of pet treat as is known in the art.

FIG. 4 illustrates the baking plate 202 or 204 comprising bone-shaped molds 206 and heating element 400 of the pet treat baking device. The heating element 400 is secured to an interior of either the top portion or the bottom portion of the device, and the baking plate 202 or 204 is positioned above the heating element 400 and secured to the top portion or the bottom portion via any suitable securing means 300 as is known in the art, such as spring clips, set screws, thumb screws, etc. The baking plate 202 or 204 can be positioned directly on the heating element 400, or the baking plate 202 or 204 can be positioned at a distance above the heating element 400. The heating element 400 would typically be a resistive, electrical heating element that would be powered by plugging the electrical cord of the device into a wall outlet. However, any other suitable heating element can be used as is known in the art. The heating element 400 acts to heat up the baking plates 202 and 204 of the device and to maintain the baking plates 202 and 204 of the device at a constant temperature during the baking process.

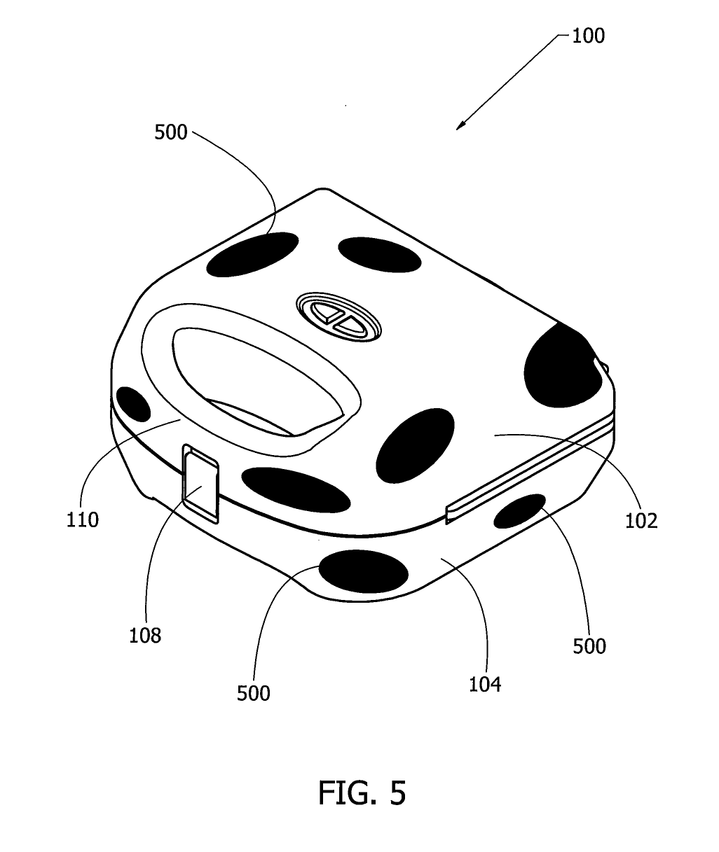

FIG. 5 illustrates the pet treat baking device 100 with a design 500. The pet treat baking device 100 can include a creative design 500. Any known design, logo, accessories, decorations, etc. can be applied to the device 100 as is known in the art without affecting the overall concept of the invention. Further, the device 100 can be manufactured in any color, size or shape as is desired. Thus, the pet treat baking device 100 can be manufactured in a variety of solid colors or patterns, or may be available in various designs and may include beads, gems, rhinestones, or other accessories as is known in the art.

Furthermore, the top portion 102 and the bottom portion 104 of the device 100 are typically the same general size and shape, and are mirror images of each other. The creative design 500 can be applied to both the top portion 102 and the bottom portion 104 as desired. Additionally, the top portion 102 and the bottom portion 104 can be secured in a closed position, via a latching component 108 to prevent the top portion 102 and bottom portion 104 from separating during transport or during the baking process. The creative design 500 can also be applied to the latching component 108 if desired. Further, the device 100 can comprise a handle 110 for ease in transporting the device 100. The handle 110 can be any suitable shape or size for a user's hand to grasp to transport the device 100, and can also have the creative design 500 applied to it as well. Thus, the creative design 500 can be applied to most any part of the device 100 as desired.

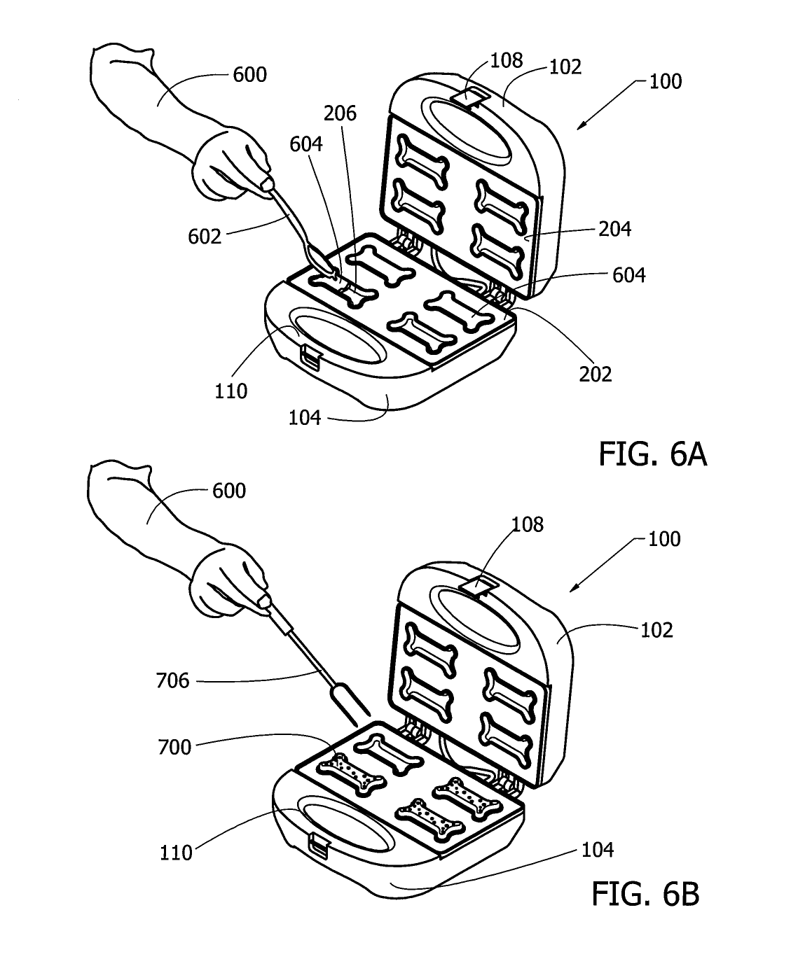

FIGS. 6 A-B illustrate the pet treat baking device 100 in use. In operation, a user 600 plugs the pet treat baking device 100 into an electrical outlet via an electrical cord. This allows the baking plates 202 and 204 of the device 100 to heat up to the required temperature. The user 600 then prepares the pet treat mix 604 in a bowl or other suitable container as is known in the art. Once the baking plates 202 and 204 of the device 100 heat up to the required temperature, the user 600 spoons the prepared pet food mix 604 into the molds 206 of the baking plate 202 using a spoon 602 or other utensil. The user 600 fills as many of the molds 206 as desired with the pet treat mix 604. Once the desired amount of molds 206 are filled, the user 600 then grasps the handle 110 of the device 100 and pulls the top portion 102 of the device 100 down to the bottom portion 104, such that the molds 206 of the baking plate 204 align with the molds 206 of the baking plate 202. This allows the pet treat mix 604 to expand and conform to the shape of the molds 206 during the baking process.

Once the device 100 is closed and latched via the latching component 108, the internal timing device is initiated. The internal timing device will then emit an audible sound, such as a bark, when the pet treats are done baking. A user 600 then unlatches the latching component 108 and opens the device 100 via grasping the handle 110 and lifting upwards. The user 600 then removes the pet treats 700 by forking the pet treats 700 with a utensil 706, or using a spatula, and placing the pet treats on a wire rack or other suitable container to cool. Once the pet treats 700 are cool, the user 600 can then feed the pet treats 700 to his or her pet and save the remaining pet treats for later feedings.

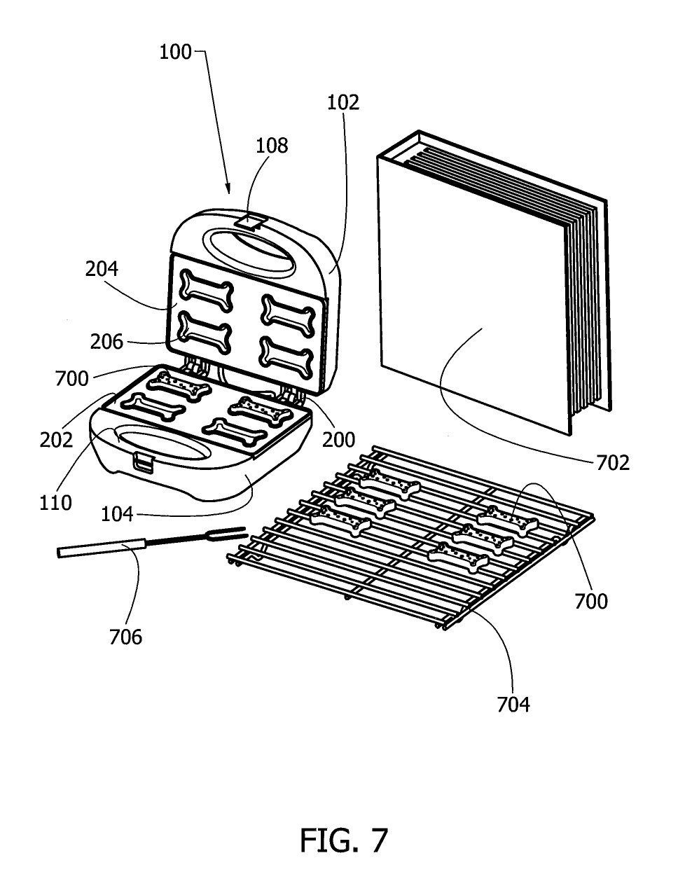

FIG. 7 illustrates the pet treat baking kit of the present invention. The pet treat baking kit comprises a pet treat baking device 100, a recipe book 702, a cooling rack 704, and a utensil 706. The pet treat baking device 100 comprises a top portion 102 and a bottom portion 104 secured together to form a hinge 200 at a first end, and a heating element secured to an interior of either the top portion 102 or the bottom portion 104 of the device 100. The top portion 102 and the bottom portion 104 can also be secured in a closed position at a second end, via a latching component 108. The device 100 can also comprise a handle 110 for ease in transporting the device 100.

Furthermore, the pet treat baking device 100 further comprises at least one non-stick baking plate 202 removably secured to the interior of the bottom portion 104 above the heating element, and at least one non-stick baking plate 204 removably secured to an interior of the top portion 102 above the heating element. The non-stick baking plates 202 and 204 comprise molds 206 that could be produced in a variety of shapes including, without limitation, the shape of a dog bone, an animal paw, or an animal. The pet treat baking device 100 further comprises an internal timing component that emits an audible sound, such as a beep, a ring, a bark, or other animal sound, when the pet treats are done baking.

The recipe book 702 of the pet treat baking kit comprises over thirty five preservative-free recipes that include allergy-sensitive treat options as well. The cooling rack 704 of the pet treat baking kit is typically a wire cooling rack for letting the pet treats 700 cool, but could be any suitable cooling rack as is known in the art. The utensil 706 of the pet treat baking kit is typically a two-pronged fork for removing the baked pet treats 700 from the pet treat baking device 100, but could be any suitable utensil as is known in the art, such as a spatula. Furthermore, the pet treat baking kit may also comprise additional baking accessories as is known in the art, such as a decorative icing bag, sprinkles or other edible confections for the tops of the pet treats 700, recipe mixes, and/or quick mixes (which require the addition of only liquid ingredients), etc. The pet treat baking kit of the present invention is designed for home use, to make pet treats that are healthy and affordable.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pet treat baking device, comprising:
a top portion and a bottom portion hingedly attached to said top portion;
a heating element secured to an interior of either the bottom portion or the top portion of the device; and
at least one baking plate removably secured to the interior of the bottom portion.

2. The pet treat baking device of claim 1, further comprising at least one baking plate removably secured to an interior of the top portion.

3. The pet treat baking device of claim 2, wherein the at least one baking plate comprises molds comprising at least one of a dog bone shape, an animal paw shape, or an animal shape.

4. The pet treat baking device of claim 1, wherein the top portion and the bottom portion are secured in a closed position at a second end, via a latching component.

5. The pet treat baking device of claim 1, further comprising an internal timing component that emits an audible sound.

6. The pet treat baking device of claim 5, wherein the audible sound comprises at least one of a beep, a ring, a bark, or other animal sound.

7. A pet treat baking kit, comprising:
a pet treat baking device;
a recipe book; and
a cooling rack.

8. The pet treat baking kit of claim 7, wherein the pet treat baking device comprises a top portion and a bottom portion secured together to form a hinge at a first end, and a heating element secured to an interior of either the top portion or the bottom portion of the device.

9. The pet treat baking kit of claim 8, wherein the top portion and the bottom portion are secured in a closed position at a second end, via a latching component.

10. The pet treat baking kit of claim 8, wherein the pet treat baking device further comprises at least one baking plate removably secured to the interior of the bottom portion.

11. The pet treat baking kit of claim 10, wherein the pet treat baking device further comprises at least one baking plate removably secured to an interior of the top portion.

12. The pet treat baking kit of claim 11, wherein the at least one baking plate comprises molds comprising at least one of a dog bone shape, an animal paw shape, or an animal shape.

13. The pet treat baking kit of claim 8, wherein the pet treat baking device further comprises an internal timing component that emits an audible sound.

14. The pet treat baking kit of claim 13, wherein the audible sound comprises at least one of a beep, a ring, a bark, or other animal sound.

15. The pet treat baking kit of claim 7, further comprising a pronged utensil.

16. A pet treat baking kit, comprising:
a pet treat baking device;
a recipe book;
a cooling rack; and
a utensil.

17. The pet treat baking kit of claim 16, wherein the pet treat baking device comprises a top portion and a bottom portion secured together to form a hinge at a first end, and a heating element secured to an interior of either the top portion or the bottom portion of the device.

18. The pet treat baking kit of claim 17, wherein the pet treat baking device further comprises at least one baking plate removably secured to an interior of the top portion, and at least one baking plate removably secured to the interior of the bottom portion.

19. The pet treat baking kit of claim 18, wherein the at least one baking plates comprise molds comprising at least one of a dog bone shape, an animal paw shape, or an animal shape.

20. The pet treat baking kit of claim 16, wherein the utensil is a two-pronged fork.
